(19) United States
(12) Patent Application Publication
(10) Pub. No.: US 2012/0086454 A1
(43) Pub. Date: Apr. 12, 2012

(54) SAMPLING SYSTEM BASED ON MICROCONDUIT LAB ON CHIP

(75) Inventor: Sunil Kumar, Celle (DE)

(73) Assignee: BAKER HUGHES INCORPORATED, Houston, TX (US)

(21) Appl. No.: 13/267,521

(22) Filed: Oct. 6, 2011

Related U.S. Application Data
(60) Provisional application No. 61/390,881, filed on Oct. 7, 2010.

(51) Int. Cl. G01V 3/18; E21B 49/08

(52) U.S. Cl. 324/324; 73/152.23

(57) ABSTRACT

An apparatus and method for estimating a parameter of interest in a downhole fluid using fluid testing module. The fluid testing module may include: a substrate comprising at least one microconduit, and a sensor. The sensor may be disposed within the at least one microconduit or external. The apparatus may include a fluid mover for moving fluid within the microconduit. The method includes estimating a parameter of interest using the fluid testing module.

### CROSS-REFERENCES TO RELATED APPLICATIONS

This application claims priority from U.S. Provisional Patent Application Ser. No. 61/390,881, filed on 7 Oct. 2010, the disclosure of which is incorporated herein by reference in its entirety.

### FIELD OF THE DISCLOSURE

This disclosure generally relates to acquiring, analyzing, and/or retrieving fluid samples. In certain aspects, the disclosure relates to analysis of fluids in a borehole penetrating an earth formation.

### BACKGROUND OF THE DISCLOSURE

Fluid evaluation techniques are well known. Broadly speaking, analysis of fluids may provide valuable data indicative of formation and wellbore parameters. Many fluids, such as formation fluids, production fluids, and drilling fluids, contain a large number of components with a complex composition.

The complex composition of such fluids may be sensitive to changes in the environment, e.g., pressure changes, temperature changes, contamination, etc. Thus, retrieval of a sample may cause unwanted separation or precipitation within the fluid. Additionally, some components of the fluid may change state (gas to liquid, or liquid to solid) when removed to surface conditions. If precipitation or separation occurs, it may not be possible to restore the original composition of the fluid.

This disclosure provides an apparatus and method to more effectively retrieve and analyze fluids.

### SUMMARY OF THE DISCLOSURE

In aspects, this disclosure generally relates to analysis of fluids. More specifically, this disclosure relates to analysis of fluids using a device formed with microconduits.

One embodiment according to the present disclosure includes an apparatus for estimating a parameter of interest in a downhole fluid, comprising: a conveyance device configured to traverse a borehole; a sampling device disposed on the conveyance device and configured to receive the downhole fluid; and at least one testing member disposed on the conveyance device, comprising: a substrate with at least one microconduit configured to receive the downhole fluid, the at least one microconduit; and at least one sensor configured to operatively contact the downhole fluid in the at least one microconduit.

Another embodiment according to the present disclosure includes a method for estimating a parameter of interest in a fluid sample, comprising: estimating the parameter of interest using an apparatus in a borehole, comprising: a conveyance device configured to traverse a borehole; a sampling device disposed on the conveyance device and configured to receive the downhole fluid; and at least one testing member disposed on the conveyance device, comprising: a substrate with at least one microconduit configured to receive the downhole fluid, the at least one microconduit; and at least one sensor configured to operatively contact the downhole fluid in the at least one microconduit.

Another embodiment according to the present disclosure includes an apparatus for containing a sample of a downhole fluid, comprising: a conveyance device; and at least one containment device disposed on the conveyance device, the containment device being configured to substantially isolate the sample in at least a portion of at least one microconduit at at least one desired parameter.

Another embodiment according to the present disclosure includes an apparatus for estimating a property of interest of a fluid, comprising: a conveyance device; and a containment device being positioned on the conveyance device and being configured to contain at least one diffracting element and the fluid.

Another embodiment according to the present disclosure includes a method for containing a fluid sample of a downhole fluid, comprising: containing the fluid sample using at least one containment device disposed in a borehole, the containment device being configured to substantially isolate the sample in at least a portion of at least one microconduit at at least one desired parameter.

Another embodiment according to the present disclosure includes a method for estimating a parameter of interest in a fluid sample, comprising: estimating the parameter of interest using at least one containment device positioned in a borehole, the containment device having a space containing at least one diffracting element and the fluid sample.

Examples of certain features of the disclosure have been summarized rather broadly in order that the detailed description thereof that follows may be better understood and in order that the contributions they represent to the art may be appreciated.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1 shows a schematic of a fluid testing module deployed in a wellbore along a wireline according to one embodiment of the present disclosure;

FIG. 2 shows a schematic of a fluid testing module according to one embodiment of the present disclosure;

FIG. 3 shows a schematic of a sensor within a microcell according to one embodiment of the present disclosure;

FIG. 4 shows a schematic of a sensor outside a microcell according to one embodiment of the present disclosure;

FIG. 5 shows a schematic of a sampling unit with a separator according to one embodiment of the present disclosure;

FIG. 6 shows a flow chart of a method for estimating a parameter of interest using a fluid testing module according to one embodiment of the present disclosure;

FIG. 7 shows a schematic of a containment device according to one embodiment of the present disclosure;

FIG. 8 shows a schematic of a fluid analyzer according to one embodiment of the present disclosure;

FIG. 9 shows a flow chart of a method for maintaining at least one parameter of a fluid sample according to one embodiment of the present disclosure; and

FIG. 10 shows a flow chart of a method for estimating a parameter of interest of a fluid sample according to one embodiment of the present disclosure.

### DETAILED DESCRIPTION

This disclosure generally relates to analysis of fluids. In one aspect, this disclosure relates to analysis of fluids using a device provided with microconduits. The term “microconduit” applies to channels small enough for fluids passing through the microconduit to demonstrate “microfluidic” behavior, as distinguished from macrofluidic behavior as understood by one of skill in the art. In general, the behavior of microfluidic flow in a microconduit diverges substantially from conventional models based on traditional Navier-Stokes equations. This disclosure encompasses conduits and fluid flow that are not characterized well by Navier-Stokes equations. In one aspect, a microconduit may have width and depth on a sub-millimeter scale, ranging from 1 to 1000 μm. In another aspect, a microconduit may have a depth on a sub-millimeter scale, but length and width above the sub-millimeter scale. In another aspect, typically, a microconduit may have a cross-sectional area of between 1 and 50,000 μm². Thus, for example, in some instances, the cross-sectional area is less than 50,000 μm², in other instances less than 10,000 μm², in still other instances less than 1000 μm², and in yet other instances less than 100 μm². In yet another aspect, a microconduit may have a cross-sectional less than 1 μm², as construction of microconduits may only be limited by methods known to those of skill in the art to form microconduits. For example, nano-imprinting methods may be used to construct microconduits with widths and depths on the order of 20 nm. In another aspect, a microconduit may be small enough that capillary action forces substantially affect a fluid in the microconduit. In one aspect, substantially affecting a fluid may mean that capillary forces are sufficient to overcome the force of gravity on the fluid. In another aspect, substantially affecting may mean that capillary forces are sufficient to overcome the viscous drag of the fluid within or in proximity to the microconduit. Particularly at the size of microconduits, the Reynolds number of a fluid in a microconduit may be very low (less than 100, in some instances less than 1, and in other instances below 10⁻³) such that viscous forces typically overwhelm inertial forces, and fluids may not mix in the traditional sense. Microconduits may come in a variety of dimensions. The cross-section of a microconduit also comes in a variety of shapes, including tubular, conical, and rectangular. Herein, the prefix “micro-” relates to objects with at least one dimension on a scale similar to that of the microconduits.

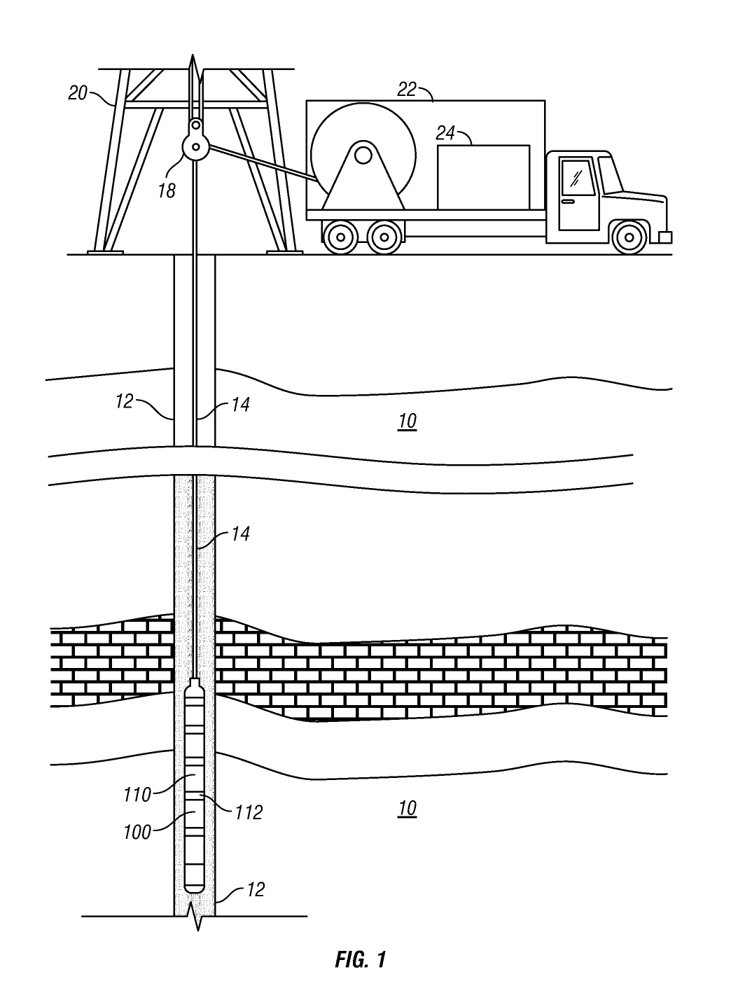

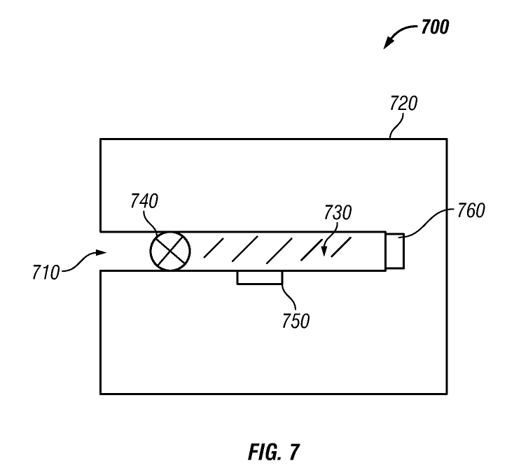

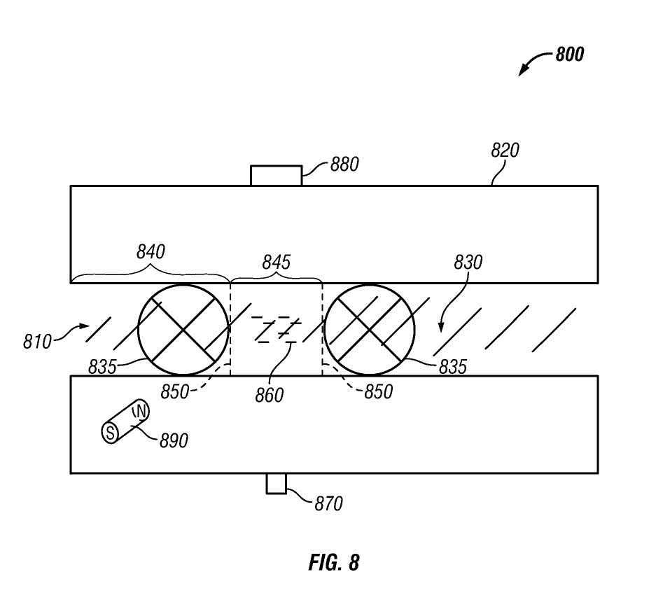

Referring initially to FIG. 1, there is schematically represented a cross-section of a subterranean formation 10 in which is drilled a borehole 12. Suspended within the borehole 12 at the bottom end of a conveyance device such as a wireline 14 is a downhole assembly 100. The wireline 14 is often carried over a pulley 18 supported by a derrick 20. Wireline deployment and retrieval is performed by a powered winch carried by a service truck 22, for example. A control panel 24 interconnected to the downhole assembly 100 through the wireline 14 by conventional means controls transmission of electrical power, data/command signals, and also provides control over operation of the components in the downhole assembly 100. The data may be transmitted in analog or digital form. The term “carrier” as used herein means any device, device component, combination of devices, media and/or member that may be used to convey, house, support, or otherwise facilitate the use of another device, device component, combination of devices, media and/or member. Downhole assembly 100 may include a fluid testing module 112. Downhole assembly 100 may also include a sampling device 110. Herein, the downhole assembly 100 may be used in a drilling system (not shown) as well as a wireline. While a wireline conveyance system has been shown, it should be understood that embodiments of the present disclosure may be utilized in connection with tools conveyed via rigid carriers (e.g., jointed tubular or coiled tubing) as well as non-rigid carriers (e.g., wireline, slickline, e-line, etc.). Some embodiments of the present disclosure may be deployed along with Logging While Drilling/Measurement While Drilling tools. In some embodiments, a containment device 700 (FIG. 7) and/or a fluid analyzer 800 (FIG. 8) may be included in downhole assembly 100 or substituted for fluid testing module 112.

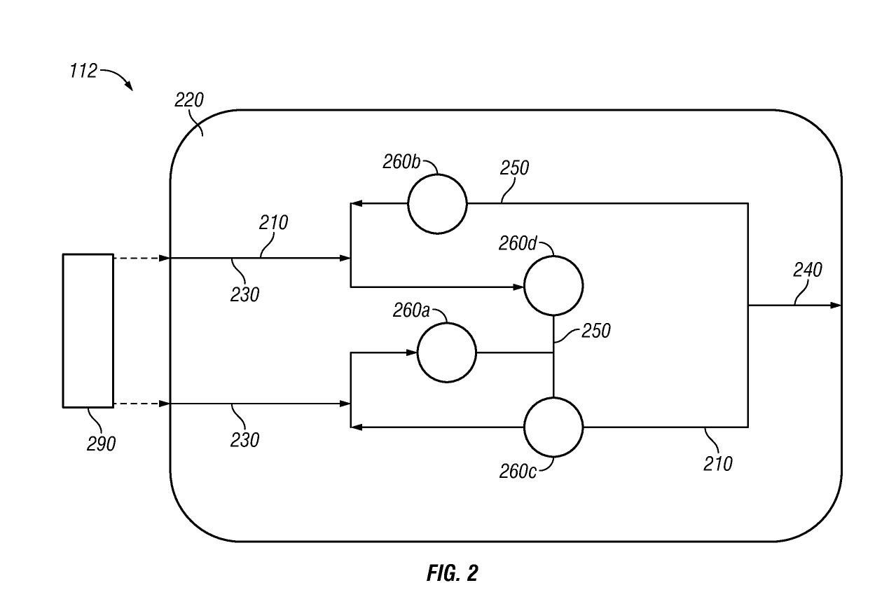

FIG. 2 shows an exemplary embodiment of fluid testing module 112 for testing one or more fluids. Fluid testing module 112 may include one or more microconduits 210 in a substrate 220. The substrate 220 may be formed of any number of suitable materials, including, but not limited to, at least one of: (i) glass, (ii) plastic, (iii) polymer, (iv) metal composite, (v) silicon, (vi) sapphire, (vii) metal, and (viii) diamond. Microconduits may be formed in the substrate by one of numerous techniques known to those of skill in the art, including, but not limited to, at least one of: (i) photolithography, (ii) chemical etching, (iii) laser etching, (iv) micromachining, (v) screen printing, (vi) thin film processing, (vii) powder blasting, (viii) molding, (ix) embossing, (x) nano-imprinting, (xi) focused ion beam machining, (xii) plasma etching, (xiii) ion milling, and (xiv) MEMS fabrication techniques. One or more microconduits 210 may form an input array 230 and an output array 240. Fluid may move into and out of the substrate 220 through input array 230 and output array 240, respectively. In some embodiments, one or more of the microconduits may serve as part of both arrays 230, 240. In some embodiments, microconduits may form a transportation network 250, which allows fluid to move from one part of the substrate to another. The transportation network 250 may be connected to input array 230, output array 240, and one or more microcells 260a-d. A microcell 260a-d may be a region of a microconduit within the substrate or simply an enlarged section of a microconduit 210. In some embodiments, a microcell may itself be a microconduit. Some microcells 260a-d may be used to store different fluids. Cleaning fluid may be stored in cleaning microcell 260b, and buffering fluid may be stored in a buffering fluid microcell 260c. A holding microcell 260d may be used to hold a desired fluid. In some embodiments, cleaning fluid and/or buffering fluid may be stored external to the substrate 220 and moved into the substrate 220 via the input array 230. An analysis microcell 260a may be in the substrate 220. By way of the transportation network 250, made up of microconduits 210, the microcells 260a-d may be physically connected to one or more of: (i) the input array 230, (ii) the output array 240, and (iii) other microcells 260a-d. In some embodiments, one or more of the microcells 260a-d may be retasked to perform an alternate function. In some embodiments, a microcell that at one point contains buffering fluid may be flushed out and filled with a desired fluid.

At the simplest level, the fluid testing module 112 may operate with a single microconduit 210 serving as input array, output array, and analysis microcell. In some embodiments, multiple fluid testing modules 112 may be conveyed into a borehole to collect one or more fluid samples per fluid testing module 112. Fluid may be moved through any of the microconduits and/or microcells by a fluid transporter 290. The fluid transporter 290 may move the fluid through the use of, but not limited to, one or more of: (i) acoustic waves, (ii) electrokinesis, (iii) electrochemistry, (iv) electrowetting, (v) optical pumping, (vi) heat pumping, and (vii) peristaltic pumping. The form of fluid transporter used may be selected based on the type of fluid being analyzed. For example, acoustic wave based fluid transport may required high frequencies (typical acoustic fluid transport operates at over 100 Hz) that may affect the fluid to be tested adversely or beneficially. In another example, electrical based fluid transport (such as electrokinesis, electrochemistry, and electrowetting) may involve implantation of electrodes into the substrate or generation of specific frequencies of electrical energy, either of which may adversely or beneficially impact the fluid to be tested. Fluid transporter 290 may move fluid into and out of the substrate along the input and output arrays 230, 240. Fluid transporter 290 may also move cleaning fluid into microconduits or microcells to clean at least part of the substrate 220. Fluid transporter 290 may also move buffering fluid to aid in moving other fluids, including the fluid to be tested, through the microconduits. This means that the fluid transporter 290 may move a fluid through a microconduit 210 directly or indirectly (via a buffering fluid). Herein, moving the fluid through or across a microconduit means that the fluid is moved at least partially through or across the microconduit 210. The use of indirect movement may be advantageous in situations where the operation of the fluid transporter 290 on the primary fluid may interfere with proper analysis of the primary fluid. In some embodiments, the fluid transporter 290 may use pressure reduction to move fluid. Arrows shown on FIG. 2 are exemplary of fluid flow through the microconduits and microcells; however, they are illustrative only. The fluid transporter 290 may be configured to reverse the flow of one or more of the microconduits 210. In some embodiments, fluid transporter 290 may move fluid sample 310 by pumping a buffer fluid into a pressurized gas or fluid filled space between the buffer fluid and the fluid 310 to be moved.

In some embodiments, the fluid testing module 112 may be divisible into internal sections. These internal sections may be permanent, where the isolation may be provided by a permanent barrier such as the substrate material, or temporary, where isolation may be provided by controllable isolation devices (not shown), such as microvalves or membranes in the microconduits or microcells to isolate internal sections. In some embodiments, at least one microconduit may include a mixer (not shown) and/or a separator (not shown). In some embodiments, micro-cantilevers may be disposed in the microconduits to estimate parameters of the fluid, such as viscosity. In some embodiments, at least one of the microconduits may include at least one sieve (not shown). In some embodiments, sieves may be cleaned or have fluid flow improved by an acoustic generator, such as an ultrasonic wave generator. In some embodiments, the filtering function of a sieve may be performed with low frequency vibrations from an acoustic generator. In some embodiments, one or more of the devices on a the fluid testing module 112, such as the fluid transporter 290, controllable isolation devices, mixer, and separator, may be powered by a power cell (not shown) located on the fluid testing module 112, including, but not limited to, one of: (i) a photoelectric cell, and (ii) an electrochemical cell. In some embodiments, the power cell may use or be located in a microcell. In another embodiment, some or all operations of the fluid testing module 112 may be powered by power generated on or within the fluid testing module 112 by using vibration energy or a heat gradient generated by a source external to the fluid testing module 112. In another embodiment, the fluid testing module 112 may be powered by power generated on or within the fluid testing module 112 by using an external electromagnetic radiation source coupled with a photovoltaic cell in a microcell within the fluid testing module 112.

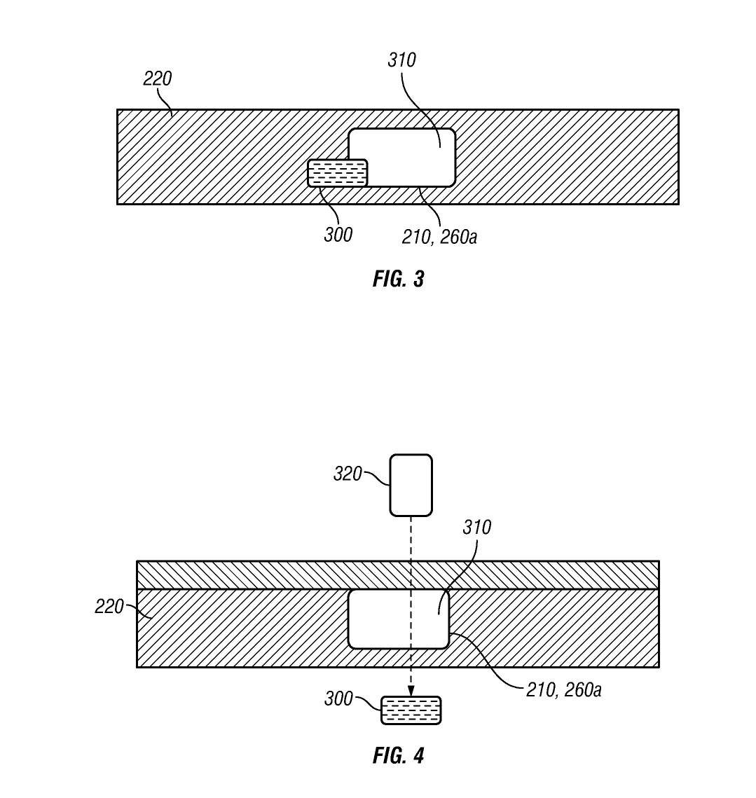

FIG. 3 shows an exemplary embodiment of an analysis microcell 260a. The microcell 260a may include a sensor 300 disposed within the microcell 260a such that at least part of the sensor may be exposed to the interior of the microcell 260a. While sensor 300 is shown attached to the substrate interior of microcell 260a, this is merely exemplary, as in other embodiments, sensor 300 may float within microcell 260a or be attached to another structure within microcell 260a. When a fluid 310 enters the microcell 260a, the fluid 310 may come in contact with sensor 300. In some embodiments, sensor 300 may receive a signal or radiation from an optional source disposed outside the microcell 260a configured to transmit the signal or radiation through the fluid 310 to sensor 300. In some embodiments, sensor 300 may have one or more sets of electrical contacts, which may be used for receiving power from an external source and/or communicating information to a receiver external to the microcell 260a. In some embodiments, the source 320 and the sensor 300 may both be located within the same or different microcells 260a-d. In some embodiments, all microcells 260a -d may be equipped with sensors 300 disposed within so that the fluid testing module 112 may be reconfigured without removal from its in situ location, such as in a borehole. Fluid 310 may be a fluid including, but not limited to, one or more of: (i) drilling fluid, (ii) production fluid, and (iii) formation fluid. Fluid 310 may be analyzed for, but not limited to, one or more of: (i) pH, (ii) H₂S, (iii) density, (iv) viscosity, (v) temperature, (vi) pressure, (vii) thermal conductivity, (viii) electrical resistivity, (ix) chemical composition, (x) reactivity, (xi) radiofrequency properties, (xii) surface tension, (xiii) infra-red absorption, (xiv) ultraviolet absorption, (xv) refractive index, and (xvi) rheological properties.

FIG. 4 shows another exemplary embodiment of the fluid testing module 112. In some embodiments, sensor 300 may be located outside of the substrate 220 but positioned such that the sensor 300 may receive a signal or radiation transmitted from an energy source 320 through the fluid 310 in the microcell 260a or a microconduit 210. In some embodiments, part or all of the substrate 220 may be at least partially transparent to at least part of the energy transmitted by energy source 320. In some embodiments, the substrate 220 may be formed with more than one layer wherein at least one layer is at least partially transparent to the energy transmitted by energy source 320. The energy source 320 may transmit at least one frequency of electromagnetic radiation. In some embodiments, the energy source 320 may be used in conjunction with sensor 300 to perform interferometric analysis (such as refractive index analysis and spectral analysis) on the fluid. In some embodiments, energy source 320 may generate acoustic waves to perform acoustic spectroscopy on the fluid 310. In yet another embodiment, fluid transporter 290 may be configured to perform a dual role as both fluid transporter and acoustic generator for fluid analysis, such as acoustic spectroscopy. In some embodiments, sensor 300 may be embedded in at least one layer of the substrate 220. In some embodiments, the analysis of the fluid 310 in the microcell 260a may be performed downhole or on the surface. On surface analysis may be performed with the fluid sample 310 in the microcell 260a or after the fluid sample 310 has been extracted from microcell 260a. In some embodiments, multiple fluid testing modules 112 may be conveyed or positioned within the borehole for each fluid testing module to receive a fluid sample.

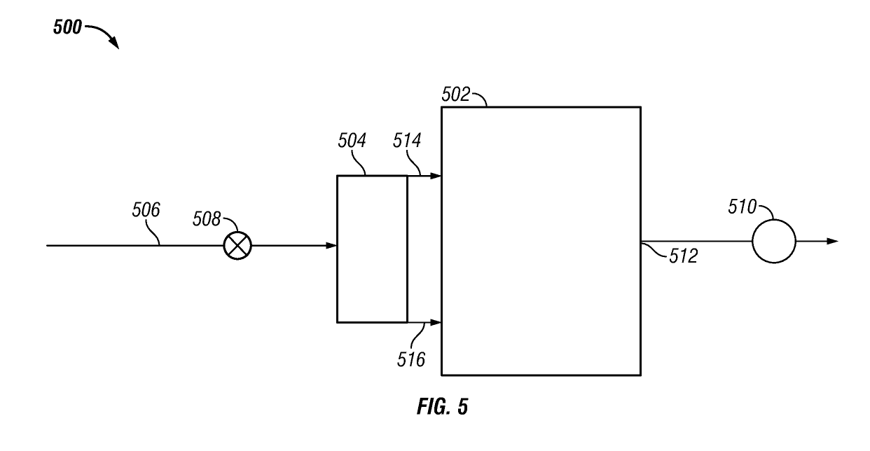

Referring now to FIG. 5, there is shown another embodiment of a sampling device 500 made in accordance with the present disclosure. The device 500 includes a sampling unit 502 that receives fluids from a separator 504. Flow into the separator may be controlled using a suitable input 506 that is controlled by a valve element 508. Flow across the sampling unit 502 may be induced by a pressure reduction device 510 that reduces pressure at a flow outlet 512 of the sampling unit 502. In one embodiment, the separator 504 may use gravity to separate the fluid phases (e.g., liquid, gases, etc.). In another embodiment, the separator 504 may include filtering elements that segregate fluids according to the size of entrained colloids. That is, for examples, a fluid stream having colloids less than a given size may be directed to a first flow branch 514. In some embodiments, the filtering elements may be pillar-like elements that have interstitial spaces of a pre-determined size. The remainder of the fluid stream may be directed along a second flow branch 516. In embodiments, the fluid stream may be separated into three or more branches, each conveying fluids having a specified characteristic. The pressure reduction device 510 may be a pump that generates a vacuum in the microconduits (not shown) in the sampling unit 502 to generate fluid flow.

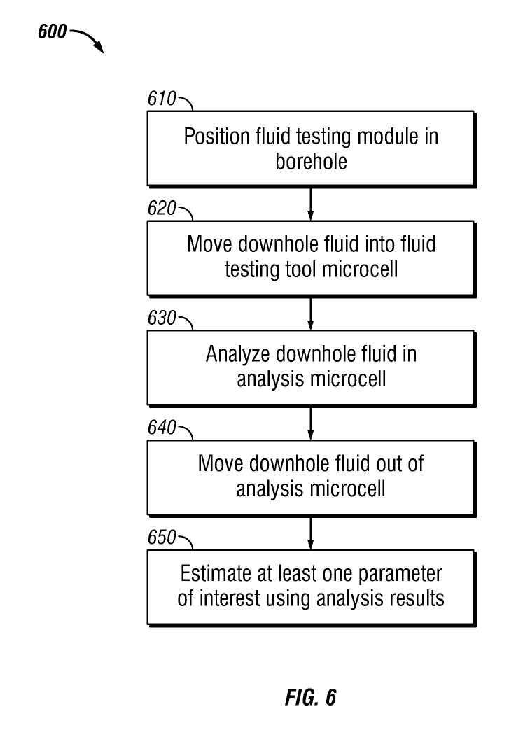

FIG. 6 shows an exemplary method 600 according to one embodiment of the present disclosure. In method 600, a fluid testing module 112 may be positioned within a borehole 12 in step 610. In some embodiments, the fluid testing module 112 may be configured to permanently reside downhole. Then, in step 620, fluid may be moved into the fluid testing module 112 from the borehole 12 or a sampling device 110 to an analysis microcell 260a, which may involve moving the fluid through input array 230. In step 630, analysis may be performed on the fluid in microcell 260a. In some embodiments, analysis may include exposing the fluid in the analysis area to energy from energy source 320. In step 640, the fluid is moved out of the analysis microcell 260a. In some embodiments, such as when the fluid testing module is a single use only device, step 640 need not be performed. In some embodiments, the fluid may be moved out of the fluid testing module 112 by way of the output array 240. In other embodiments, the fluid may be moved from a first analysis microcell 260a to another analysis microcell (not shown) for another test. In some embodiments, step 640 may be performed by the fluid transporter 290 moving the fluid directly (such as with acoustic waves) or indirectly (such as flushing the analysis microcell with buffering fluid or cleaning fluid). In some embodiments, the cleaning and/or buffering fluid may be supplied from one or more microcells 260a-d, supplied from the surface, and/or extracted from the downhole environment. In some embodiments, particularly when the cleaning and/or buffering fluid may be extracted from the downhole environment, the fluid testing module 112 may be configured to process the extracted fluid into a suitable buffering and/or cleaning fluid. In step 650, a parameter of interest of the fluid may be estimated based on the estimate by the sensor 300 in the analysis microcell 260a. In some embodiments, a plurality of fluid testing modules 112 may be operated simultaneously. In one embodiment, fluid tested in a first fluid testing tool may be moved to a second fluid testing tool for the same or a different analysis. In yet another embodiment, a first fluid may be analyzed in step 630, and then a second fluid may be moved into the same analysis microcell 260a without the first fluid being removed, hence not performing step 640.

In some embodiments, the method may include one or more modes of investigation, including, but not limited to, droplet investigation and continuous investigation. Continuous investigation may include simultaneous testing of fluids taken from one or more samples of fluid. Droplet investigation may include performing an analysis of a fluid and then moving the tested fluid to another fluid testing module or a different location on the same fluid testing module for additional testing. In some embodiments, the fluid testing module may be sufficient in capability to perform both modes of investigation within the same substrate.

FIG. 7 shows an exemplary embodiment of a containment device 700, in which at least one microconduit 710 is formed in a substrate 720 to contain a sample 730. The containment device 700 may be configured to be conveyed into a borehole with a conveyance device 14. The containment device 700 may include an isolator 740 configured to isolate the sample 730 and maintain the sample 730 at a desired parameter or parameters. Illustrative parameters include, but are not limited to, pressure and temperature. The sample 730 may be isolated from the downhole environment, and the isolation may be maintained while at the surface. Illustrative isolators include microvalves, piezoelectric elements, and membranes. In one embodiment, the containment device 700 may include a temperature regulator 750 configured to keep the sample 730 at a desired temperature. The temperature regulator 750 may include a heater, a thermostat, and a control circuit. The temperature regulator 750 may include one or more of: (i) a heating element and (ii) a cooling element. A pressure regulator 760 may be operably connected to the sample 730 and configured to keep the sample 730 at a desired pressure. In some embodiments, the temperature regulator 750, the pressure regulator 760, or both may be optional. The isolation need not be complete, as the isolation may only be sufficient to pressure the fluid sample (i.e., suitably isolated).

In some embodiments, a fluid mover (not shown) may be used to flow the fluid sample out of the microconduit 710. The fluid mover may be a buffer fluid that is pumped or otherwise conveyed into the microconduit 710 to displace the fluid sample 730. In other embodiments, the pressure regulator 760 may be used to move the fluid sample 730 out of the microconduit 710. For example, the pressure regulator 760 may include a movable element (e.g., a piston head) that moves through the microconduit 710. The fluid sample 730 may be directed out of the isolator 740. In other embodiments, a separate conduit may be used to direct fluid out of the microconduit 710.

In one embodiment, the microconduit 710 may be formed as a well or “blind hole” and the isolator 740 may be configured as a sealing element or valve through which the fluid enters and leaves. In other embodiments not shown, the microconduit may be formed as a flow channel that includes two spaced apart isolators. In such embodiments, fluid flow may occur through the microconduit in one direction.

FIG. 8 shows an exemplary fluid analyzer 800 according to the present disclosure that uses one or more diffracting elements to obtain information relating to a fluid sample. The diffracting element(s) may be in a conduit or other fluid-containing structure. The fluid containing structure can be of any suitable size or dimension. In one non-limiting embodiment, the fluid analyzer 800 may include at least one microconduit 810 in a substrate 820, the at least one microconduit 810 being configured to receiver a fluid sample 830. The at least one microconduit 810 may be divided into at least two chambers 840, 845 by at least one sieve 850. As used herein, a sieve refers to any structure that prevents the passage of objects of a desired size. In the embodiment shown, two sieves 850 form a volume that may be considered an analysis chamber 845. At least one diffracting element 860 may be located within chamber 845, and sieves 850 may be configured to allow passage of the fluid sample 830 but not passage of the at least one diffracting element 860. In some embodiments, the sieves may be optional and the at least one diffracting element may be introduced to the fluid sample 830 prior to the fluid sample 830 being received in analysis chamber 845. Herein, a diffracting element may have at least one dimension that is less than 1 micrometer in length and may be responsive to a magnetic field. In some embodiments, the at least one diffracting element may have a length of between about 2 nanometers and about 500 micrometers, while having a width of between 2 nanometers and 500 nanometers. In some embodiments, the at least one diffracting element may be one of: (i) spherical and (ii) oblong. A second electromagnetic source 870 may be configured to transmit electromagnetic energy through the sample 830 to a sensor 880. The second electromagnetic source 870 may be configured to transmit, but is not limited to, one or more of: (i) x-rays, (ii) ultraviolet light, (iii) visible light, (iv) radio waves, and (v) infra-red light. Similarly, sensor 880 may be configured to receive, but is not limited to, one or more of: (i) x-rays, (ii) ultraviolet light, (iii) visible light, (iv) radio waves, and (v) infra-red light. Sensor 880 may be located inside or outside the substrate 820 and will receive the electromagnetic radiation after it has passed through the sample 830 in the chamber 845. At least part of substrate 820 may be formed of a material that allows the transmission of electromagnetic radiation at selected frequencies. A first electromagnetic source 890 may be in operable communication with the at least one diffracting element 860. The first electromagnetic source 890 may be one of: (i) an electromagnet, (ii) a permanent magnet, and (iii) an electric field generator. In some embodiments, the fluid sample 830 may flow through the at least one microconduit 810, while in other embodiments, the fluid sample 830 may be stationary. In some embodiments, one or more optional isolation valves 835 may exist to isolate the fluid sample 830 within one or more chambers 845. In some embodiments, the fluid analyzer 800 may include a fluid mover (not shown) to control the movement of the fluid sample 830 or move some or all of the fluid sample 830 out of the microconduit 810.

It should be understood that the sieves may be omitted in some configurations wherein the diffracting elements may be otherwise secured within the at least one microconduit 810. For example, a magnetic field may be applied to the diffracting elements to retain the diffracting elements within the microconduit, by attraction or repulsion, while allowing the sample egress from the microconduit.

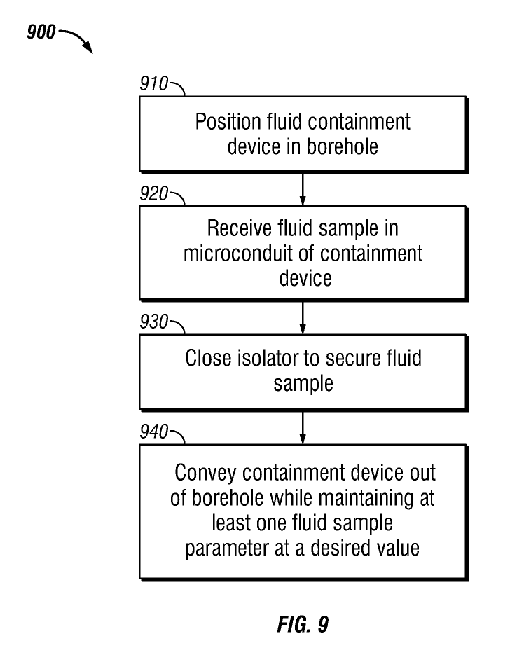

FIG. 9 shows a flow chart of an exemplary method 900 using containment device 700 to secure a fluid sample 730. In step 910, the containment device 700 may be conveyed into the borehole 12 by the conveyance device 14. One or more sampling tools may be operated to acquire a fluid sample of interest. This fluid may be a naturally occurring fluid (e.g., formation fluid) or an engineered fluid (e.g., drilling mud, fracturing fluid, etc.). The sampling tool may include the containment device 700 and/or the containment device 700 may be separate from the sampling tool. Thus, in step 920, a fluid sample 730 may be received by microconduit 710 from one or more of: (i) formation fluid, (ii) drilling fluid, and (iii) production fluid. In step 930, isolator 740 may be closed to secure the fluid sample 730 within containment device 700. In step 940, the containment device 700 may be conveyed out of the borehole, while maintaining at least one fluid sample parameter at a desired value. In some embodiments, temperature regulator 750 and/or pressure regulator 760 may be used to maintain the sample 730 at a desired temperature and/or a desire pressure, respectively.

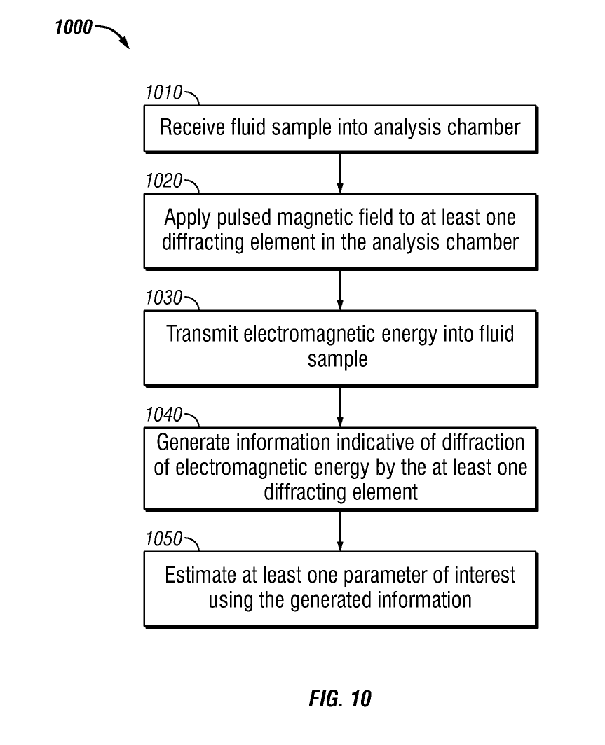

FIG. 10 shows a flow chart of an exemplary method 1000 using fluid analyzer 800 to estimate a parameter of interest of a fluid sample 830. The at least one parameter of interest may include, but is not limited to, at least one of: (i) viscosity, (ii) density, (iii) viscosity-density product, (iv) thermoconductivity, and (v) electroconductivity. In step 1010, fluid sample 830 may be received by analysis chamber 845 of microconduit 810. In step 1020, the first electromagnetic source 890 may apply a pulsed magnetic field (or an electric field) to the at least one diffracting element 860, causing the diffracting element to move. Movement of the at least one diffracting element 860 due to the applied pulsed magnetic field may include at least one of: (i) rotation and (ii) vibration. In step 1030, the second electromagnetic source 870 may transmit electromagnetic radiation into fluid sample 830, which may be diffracted by the at least one diffracting element 860. In step 1040, information about the diffracted electromagnetic radiation received by sensor 880 may be generated by the sensor 880 and communicated to at least one processor (not shown). In some embodiments, the frequency of the first electromagnetic source 890 may be varied to find the critical frequency, ωᵣ, where the diffraction of electromagnetic radiation from the second electromagnetic source 870 may be maximized, hence the amplitude of the electromagnetic radiation received by sensor 880 would be minimized. The critical frequency may vary for the same fluid sample 830 if diffracting elements of a different size are used. Critical frequency may also vary depending on the movement of the particles (rotating vs. vibrating). The amount of diffraction of light may vary with frequency and viscosity of the fluid sample 830. In step 1050, at least one parameter of interest may be estimated using the sensor information. In some embodiments, the second electromagnetic source 870 may be configured to transmit coherent or incoherent radiation. In some embodiments, the microconduit 810 may have multiple analysis chambers 845 and/or the analysis chamber 845 may have a different cross-sectional area than chamber 840. In some embodiments, the first electromagnetic source 890 may be used to cause the at least one diffracting element 860 to vibrate, where the damping of the vibrations may be estimated by a sensor (not shown) to estimate a parameter of interest, such as viscosity, density, or other rheological properties of the fluid sample 830. In some embodiments, the amount of energy used by the first electromagnetic source 890 to maintain the motion of the diffracting elements 860 may be used to estimate a parameter of interest, as the energy consumption may be indicative of a damping characteristic of the fluid sample 830. Method 1000 may be performed in situ and/or at the surface. In some embodiments, the dispersal pattern of multiple diffracting elements when the fluid sample 830 enters analysis chamber 845 may be used to estimate a parameter of interest, even before the pulsed magnetic field has been applied. In some embodiments, the size of the at least one diffracting element 860 may vary based on the contents of the fluid sample 830, and a parameter of interest, such as hydrocarbon fraction, may be estimated by comparing the size of the at least one diffracting element 860 before and after contact with the fluid sample 830.

While the present teachings have been discussed in the context of hydrocarbon producing wells, it should be understood that the present teachings may be applied to geothermal wells, groundwater wells, subsea analysis, etc. Also, the present teachings may be applied to surface-based fluid recovery and analysis.

While the foregoing disclosure is directed to the one mode embodiments of the disclosure, various modifications will be apparent to those skilled in the art. It is intended that all variations be embraced by the foregoing disclosure.

What is claimed is:

1. An apparatus for containing a sample of a downhole fluid, comprising:
a conveyance device; and
at least one containment device disposed on the conveyance device, the containment device being configured to substantially isolate the fluid sample in at least a portion of at least one microconduit at at least one desired parameter.

2. The apparatus of claim 1, wherein the at least one containment device includes an isolation device configured to isolate the fluid sample in the at least one microconduit.

3. The apparatus of claim 1, wherein the at least one desired parameter includes a desired pressure.

4. The apparatus of claim 1, wherein the at least one containment device includes a heater configured to maintain the sample at a desired temperature.

5. The apparatus of claim 1, further comprising an electromagnetic source configured to direct electromagnetic radiation to the fluid sample.

6. The apparatus of claim 5, further comprising:
at least one diffracting element in the at least one microconduit.

7. The apparatus of claim 6, where the at least one diffracting element is responsive to an electromagnetic field.

8. An apparatus for estimating a property of interest of a fluid, comprising:
a conveyance device; and
a containment device being positioned on the conveyance device and being configured to contain at least one diffracting element in the fluid sample.

9. The apparatus of claim 8, further comprising a sensor configured to generate diffraction information in response to an electromagnetic radiation from the fluid sample.

10. The apparatus of claim 8, further comprising: a first electromagnetic source configured to energize the at least one diffracting element; and a second electromagnetic source configured to transmit an electromagnetic radiation into the fluid sample.

11. The apparatus of claim 10, where the first electromagnetic source is configured to generate at least one of: (i) an electric field and (ii) a magnetic field.

12. The apparatus of claim 10, where the first electromagnetic source is pulsed.

13. The apparatus of claim 10, where the transmitted electromagnetic radiation is at least one of: (i) radio waves, (ii) infra-red light, (iii) visible light, (iv) ultraviolet light, and (v) x-rays.

14. The apparatus of claim 8, where the at least one diffracting element is responsive to at least one of: (i) an electric field and (ii) a magnetic field.

15. A method for containing a fluid sample of a downhole fluid, comprising:
containing the fluid sample using at least one containment device disposed in a borehole, the containment device being configured to substantially isolate the sample in at least a portion of at least one microconduit at at least one desired parameter.

16. The method of claim 15, further comprising:
positioning the at least one containment device in the borehole.

17. A method for estimating a parameter of interest in a fluid sample, comprising:
estimating the parameter of interest using at least one containment device positioned in a borehole, the containment device having a space containing at least one diffracting element in the fluid sample.

18. The method of claim 17, wherein the at least one diffracting element is responsive to an electromagnetic field.

19. The method of claim 17, further comprising:
receiving a fluid sample into the space.

20. The method of claim 17, further comprising:
energizing the at least one diffracting element;
transmitting electromagnetic radiation through the fluid sample; and
generating a signal using a sensor responsive to electromagnetic radiation.
